(19) United States
(12) Patent Application Publication
(10) Pub. No.: US 2019/0348062 A1
(43) Pub. Date: Nov. 14, 2019

(54) SYSTEM AND METHOD FOR ENCODING DATA USING TIME SHIFT IN AN AUDIO/IMAGE RECOGNITION INTEGRATED CIRCUIT SOLUTION

(71) Applicant: GYRFALCON TECHNOLOGY INC., Milpitas, CA (US)

(72) Inventors: Xiang Gao, San Jose, CA (US); Lin Yang, Milpitas, CA (US); Wenhan Zhang, Mississauga (CA)

(73) Assignee: GYRFALCON TECHNOLOGY INC., Milpitas, CA (US)

(21) Appl. No.: 15/974,558

(22) Filed: May 8, 2018

(51) Int. Cl. G10L 25/24; G06F 15/18; G10L 19/02; G06N 3/04

(52) U.S. Cl. CPC G10L 25/24; G06F 15/18; G06N 3/10; G06N 3/049; G10L 19/0204

(57) ABSTRACT

A system for encoding data in an artificial intelligence (AI) integrated circuit solution may include a processor configured to receive image/voice data and generate a sequence of two-dimensional (2D) arrays each array being shifted from a preceding 2D array in the sequence by a time difference. The system may load the sequence of arrays into an AI integrated circuit, feed each of the 2D arrays in the sequence into a respective channel in an embedded cellular neural network architecture in the AI integrated circuit. The system may generate an image/voice recognition result from the embedded cellular neural network architecture and output the image/voice recognition result. The sequence of 2D arrays in the image recognition may include a sequence of output images. The sequence of 2D arrays in the voice recognition may include 2D frequency-time arrays. Sample data may be encoded in a similar manner for training the cellular neural network.

### BACKGROUND

This patent document relates generally to encoding data into an artificial intelligence integrated circuit, and in particular, to encoding data in an audio/image recognition integrated circuit solution.

Solutions for implementing voice and/or image recognition tasks in an integrated circuit face challenges of losing data precision or accuracy due to limited resources in the integrated circuit. For example, a single low-power chip (e.g., ASIC or FPGA) for voice or image recognition tasks in a mobile device is typically limited in chip size and circuit complexity by design constraints. A voice or image recognition task implemented in such a low-power chip cannot use data that has the same numeric precision, nor can it achieve the same accuracy as when performing the tasks in a processing device of a desktop computer. For example, an artificial intelligence (AI) chip e.g., an AI integrated circuit in a mobile phone may have an embedded cellular neural network (CeNN) architecture that has only 5 bits per channel to represent data values, whereas CPUs in a desktop computer or a server in a cloud computing environment use a 32-bit floating point or 64-bit double-precision floating point format. As a result, image or voice recognition models, such as a convolutional neural network (CNN), when trained on desktop or server computers and transferred to an integrated circuit with low bit-width or low numeric precision, will suffer a loss in performance.

Additionally, AI integrated circuit solutions may also face challenges in encoding data to be loaded into the AI chip having physical constraints. Only meaningful models can be obtained through the training if data are arranged (encoded) properly inside the chip. For example, if intrinsic relationships exist among events that occur proximately in time (e.g., waveform segments in a syllable or in a phrase in a speech), then the intrinsic relationships may be discovered by the training process when the data that are captured proximately in time are arranged to be loaded to the AI chip and processed by the AI chip concurrently. In another example, if two events in a video are correlated (e.g., a yellow traffic light followed by a red light), then data that span over the time period between yellow light and red light may needed in order to obtain a meaningful model from training. Yet, obtaining a meaningful model can be challenging due to physical constraints of an AI chip, for example, the limited number of channels.

This patent disclosure is directed to systems and methods for addressing the above issues and/or other issues.

### BRIEF DESCRIPTION OF THE DRAWINGS

The present solution will be described with reference to the following figures, in which like numerals represent like items throughout the figures.

FIG. 1 illustrates an example system in accordance with various examples described herein.

FIG. 2 illustrates a diagram of an example of a process for implementing a voice recognition task in an AI chip.

FIG. 3 illustrates an example of multiple frequency-time arrays of voice signals for loading into respective channels in an AI chip.

FIG. 4 illustrates a diagram of an example of a process for implementing an image recognition task in an AI chip.

FIG. 5 illustrates an example of multiple frames in an image for loading into respective channels in an AI chip.

FIG. 6 illustrates various embodiments of one or more electronic devices for implementing the various methods and processes described herein.

### DETAILED DESCRIPTION

As used in this document, the singular forms “a”, “an”, and “the” include plural references unless the context clearly dictates otherwise. Unless defined otherwise, all technical and scientific terms used herein have the same meanings as commonly understood by one of ordinary skill in the art. As used in this document, the term “comprising” means “including, but not limited to.” Unless defined otherwise, all technical and scientific terms used in this document have the same meanings as commonly understood by one of ordinary skill in the art.

Each of the terms “artificial intelligence logic circuit” and “AI logic circuit” refers to a logic circuit that is configured to execute certain AI functions such as a neural network in AI or machine learning tasks. An AI logic circuit can be a processor. An AI logic circuit can also be a logic circuit that is controlled by an external processor and executes certain AI functions.

Each of the terms “integrated circuit,” “semiconductor chip,” “chip” and “semiconductor device” refers to an integrated circuit (IC) that contains electronic circuits on semiconductor materials, such as silicon, for performing certain functions. For example, an integrated circuit can be a microprocessor, a memory, a programmable array logic (PAL) device, an application-specific integrated circuit (ASIC) or others. An integrated circuit that contains an AI logic circuit is referred to as an AI integrated circuit or an AI chip.

The term “AI chip” refers to a hardware- or software-based device that is capable of performing functions of an AI logic circuit. An AI chip can be a physical AI integrated circuit or can be a virtual chip, i.e., software-based. For example, a virtual AI chip may include one or more process simulators to simulate the operations of a physical AI integrated circuit.

The term of “AI model” refers to data that include one or more weights that are used for, when loaded inside an AI chip, executing the AI chip. For example, an AI model for a given CNN may include the weights for one or more convolutional lavers of the CNN.

Each of the terms “data precision,” “precision” and “numerical precision” as used in representing values in a digital representation in a memory refers to the maximum number of values that the digital representation can represent. If two data values are represented in the same digital representation, for example, as an unsigned integer, a data value represented by more bits in the memory generally has a higher precision than a data value represented by fewer bits. For example, a data value using 5 bits has a lower precision than a data value using 8 bits.

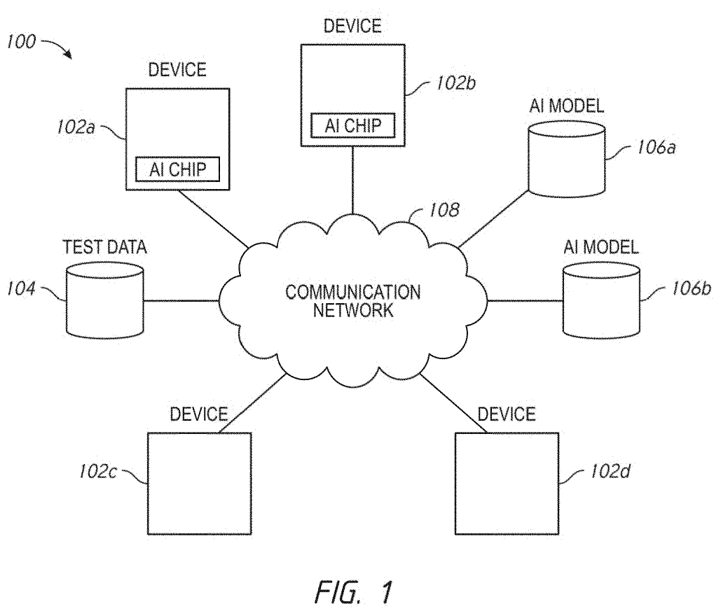

With reference to FIG. 1, a system 100 includes one or more processing devices 102a-102d for performing one or more functions in an artificial intelligence task. For example, some devices 102a, 102b may each have one or more AI chips. The AI chip may be a physical AI integrated circuit. The AI chip may also be software-based, i.e., a virtual AI chip that includes one or more process simulators to simulate the operations of a physical AI integrated circuit. A processing device may be coupled to an AI integrated circuit and contain programming instructions that will cause the AI integrated circuit to be executed on the processing device. Alternatively, and/or additionally, the a processing device may also have a virtual AI chip installed and the processing device may contain programming instructions configured to control the virtual AI chip so that the virtual AI chip may perform certain AI functions.

System 100 may further include a communication network 108 that is in communication with the processing devices 102a-102d. Each processing device 102a-102d in system 100 may be in electrical communication with other processing devices via the communication network 108. Communication network 108 may include any suitable communication links, such as wired (e.g., serial, parallel, optical, or Ethernet connections) or wireless (e.g., Bluetooth, mesh network connections) or any suitable communication network later developed. In some scenarios, the processing devices 102a-102d may communicate with each other via a peer-to-peer (P2P) network or a client/server based communication protocol. System 100 may also include one or more AI models 106a-106b. System 100 may also include one or more databases that contain test data for training the one or more AI models 106a-106b.

In some scenarios, the AI chip may contain an AI model for performing certain AI tasks. For example, an AI model may be a CNN that is trained to perform voice or image recognition tasks. A CNN may include multiple convolutional layers, each of which may include multiple weights. In the case of physical AI chip, the AI chip may include an embedded cellular neural network that has a memory for containing the multiple weights in the CNN. In some scenarios, the memory'in a physical AI chip may be a one-time-programmable (OTP) memory that allows a user to load a CNN model into the physical AI chip once. Alternatively, a physical AI chip may have a random access memory (RAM) or other types of memory that allows a user to load and/or update a CNN model in the physical AI chip.

In the case of virtual AI chip, the AI chip may include a data structure to simulate the cellular neural network in a physical AI chip. A virtual AI chip can be of particular advantageous when multiple tests need to be run over various CNNs in order to determine a model that produces the best performance (e.g., highest recognition rate or lowest error rate). In each test run, the weights in the CNN can vary and, each time the CNN is updated, the weights in the CNN can be loaded into the virtual AI chip without the cost associated with a physical AI chip. After the CNN model is determined, the final CNN model may be loaded into a physical AI chip for real-time applications.

Each of the processing devices 102a-102d may be any suitable device for performing an AI task (e.g., voice recognition, image recognition, scene recognition etc.), training an AI model 106a-106b or capturing test data 104. For example, the processing device may be a desktop computer, an electronic mobile device, a tablet PC, a server or a virtual machine on the cloud. Various methods may be implemented in the above described embodiments in FIG. 1 to accomplish various data encoding methods, as described in detail below.

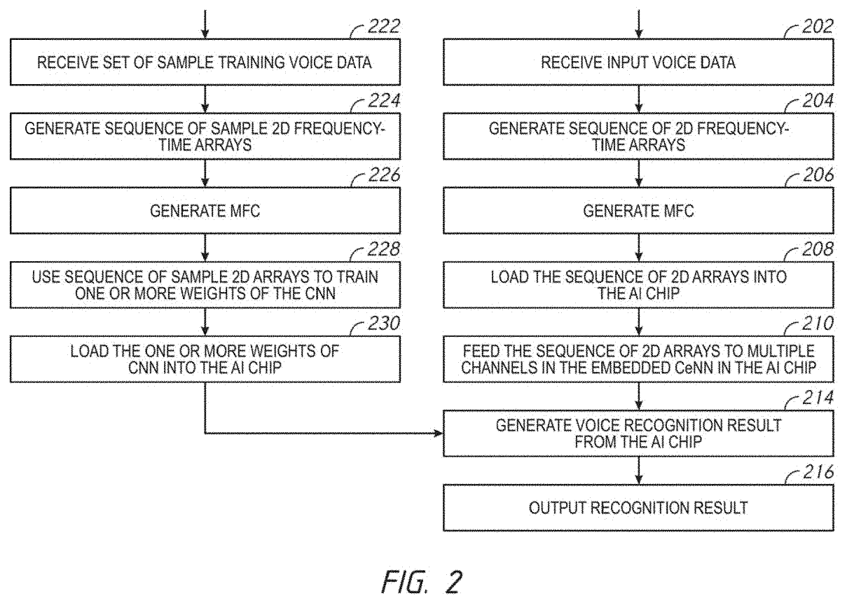

With reference to FIG. 2, methods of encoding voice data for loading into an AI chip are provided. In some scenarios, an AI integrated circuit may have an embedded CeNN which may include a number of channels for implementing various AI tasks. In some scenarios, an encoding method may include receiving input voice data. The input voice data may include one or more segments of an audio waveform 202. A segment of an audio waveform may include an audio waveform of voice or speech, for example, a syllable, a word, a phrase, a spoken sentence, and/or a speech dialog of any length. Receiving the input voice data may include: receiving a segment of waveform of voice signals directly from an audio capturing device, such as a microphone; and converting the waveform to a digital form. Receiving input voice data may also include retrieving voice data from a memory. For example, the memory may contain voice data captured by an audio capturing device. The memory may also contain video data captured by a video capturing device, such as a video camera. The method may retrieve the video data and extract the audio data from the video data.

The encoding method may also include generating a sequence of 2D frequency-time arrays using the received voice data 204. For example, each frequency-time 2D array may be a spectrogram. The 2D spectrogram may include an array of pixels (x, y), where x represents a time in the segment of the audio waveform, y represents a frequency in the segment of the audio waveform, each pixel (x, y) has a value representing an audio intensity of the segment of the audio waveform at time x and frequency y. Additionally, an for alternatively, the encoding method may generate a Mel-frequency cepstrum (MFC) 206 based on the frequency-time array so that each pixel in the frequency-time array becomes a MFC coefficient (MFCC). In some scenarios, the MFCC array may provide evenly distributed power spectrum for data encoding, which may allow the system to extract speaker independent features.

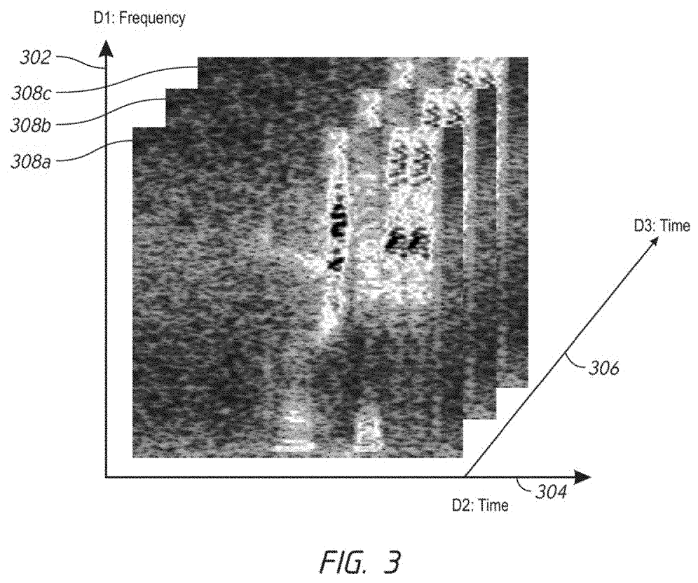

With further reference to FIG. 2, in generating the sequence of 2D frequency-time arrays 204, each 2D array in the sequence may represent a 2D spectrogram of the voice signal at a time step. For example, as shown in FIG. 3, the plane that includes frequency axis 302 and time axis 304 (i.e. D1-D2) plane represents a frequency-time array, such as a spectrum or MFCC array. Each 2D frequency-time allay 308a-308c represent the 2D frequency-time array (e.g., the spectrogram) at a time instance along time axis 306 (D3). In sonic scenarios, in voice recognition, each time step in the sequence of 2D frequency-time arrays may be selected to be small to capture certain transient characteristics of a voice signal. For example, an AI chip may have 16 channels. Consequently, the sequence of 2D frequency-time arrays may correspondingly have 16 arrays to be respectively uploaded to one of the 16 channels in the AI chip. The time shift between adjacent arrays in the sequence may vary depending on the applications.

In a non-limiting example, in voice application, the time step in axis 304 (D2) may be equally spaced, for example, at 10 ms or 50 ms. In other words, each 2D array in the sequence may represent the frequency-time array in a span of 10 ms or 50 ms. This time duration represents a time period in the audio waveform of the voice signals. In some scenarios, each time step along axis 306 (D3) may be 5 ms, for example. In other words, if there are 16 frequency-time arrays in the sequence that correspond to 16 channels in the AI chip, then loading all 16 frequency-time arrays into the AI chip may cover 16×5=80 ms. In some scenarios, the sequence of 2D frequency-time arrays may be loaded to the first layer of a CNN in an AI chip. A small time step in axis 306 may allow the first layer in fie CNN to be able to see more samples in a small time window. Whereas each 2D array in the sequence may have a low resolution (e.g., 224×224), haying multiple 2D arrays that are proximate in time in a sequence will improve the input precision.

In another non-limiting example, the time step in the sequence of 2D frequency-time arrays may be larger than 5 ms, such as, 1 second, 2 seconds etc. Or, the time step along axis 306 (D3) could be larger than the time step in axis 394 (D2). This will allow the CNN layer in the chip to include data that cover a large time span in the audio waveform, and as a result, may improve the accuracy of the AI chip. Because the filter in the CNN now covers longer time frames, it can capture some transient characteristics of a voice, such as “tone”, short or long sounds etc.

Returning to FIG. 2, the method may further include loading the sequence of 2D arrays into the AI chip 208. Each of the 2D arrays in the sequence may have an array of pixels that correspond to the array of pixels in the preceding 2D array in the sequence but time-shifted by a time difference (i.e., the time step in axis 306), as described above with reference to FIG. 3. In loading the sequence of 2D arrays into the AI chip 298, each 2D array in the sequence may respectively be loaded into a corresponding channel in the CeNN in the AI chip.

In generating recognition results for the input voice data, the method may further include: executing, by the AI chip, one or more programming instructions contained in the AI chip to feed the sequence of 2D arrays 210 into multiple channels in the embedded CeNN in the AI integrated circuit; generating a voice recognition result from the embedded CeNN 214 based on the sequence of 2D arrays; and outputting the voice recognition result 216. Outputting the voice recognition result 216 may include storing a digital representation of the recognition result to a memory device inside the AI chip or outside the AI chip, the content of the memory can be retrieved by the application running the AI task, an external device or a process. The application running the AI task may be an application running inside the AI integrated circuit should the AI integrated circuit also have a processor. The application may also run on a processor on the communication network (102c-102d in FIG. 1) external to an AI chip, such as a computing device or a server on the cloud, which may be electrically coupled to or may communicate remotely with the AI chip. Alternatively, and/or additionally, the AI chip may transmit the recognition result to a processor running the AI application or a display.

In a non-limning example, the embedded CeNN in the AI chip may have a maximal number of channels, e.g., 3, 8, 16, 128 or other numbers, and each channel may have a 2D array, e.g., 224 by 224 pixels, and each pixel value may have a depth, such as, for example, 5 bits. Input data for any AI tasks using the AI chip must be encoded to adapt to such hardware constraints of the AI chip. For example, loading the sequence of 2D arrays 208 into the above example of AI chip having three channels may include loading a sequence of three 2D arrays of size 224×224, each pixel of the 2D array having a 5-bit value. The above described 2D array sizes, channel number and depth for each channel are illustrative only. Other sizes may be possible. For example, the number of 2D arrays for encoding into the CeNN in the AI chip may be smaller than the maximum channels of the CeNN in the AI chip.

In some scenarios, the embedded CeNN in the AI chip may store a CNN that was trained and pre-loaded. The structure of the CNN may correspond to the same constraints of an AI integrated circuit. For example, for the above illustrated example of the embedded CeNN, the CNN may correspondingly be structured to have three channels, each having an array of 224×224 pixels, and each pixel may have a 5-bit value. The training of the CNN may include encoding the training data in the same manner as described in the recognition process (e.g., block 204, 206), and an example of a training process is further explained, as below.

With continued reference to FIG. 1, in some scenarios, a training method may include: receiving a set of sample training voice data, which may include one or more segments clan audio waveform 222; and using the set of sample training voice data to generate one or more sequences of sample 2D frequency-time arrays 224. Each sequence of sample 2D training frequency-time array is generated in a similar manner as in block 204. For example, each sample 2D frequency-time array in a sequence may be a spectrogram, in which each pixel (x, y) represents an audio intensity of the segment of the audio waveform at time x and frequency. Alternatively, and/or additionally, similar to block 206, the method may include generating a MFCC array 226.

In some scenarios, in generating the sequence of sample 2D frequency-time arrays 224, the scales and resolutions for each axis (e.g., 302, 304, 306 in FIG. 3) may be identical to those used in block 204, 206. In a non-limiting example, in training the CNN, the time difference between adjacent slides (e.g., along axis 306 in FIG. 3) may be a fixed time interval. In such case, the time difference between adjacent slides in performing a recognition task may also use the same fixed time interval. In some scenarios, the scales and resolutions for each axis (e.g., 302, 304, 306 in FIG. 3) may not be identical to those used in block 204, 106. For example, in training, the time difference between adjacent slides may be a random value within a time range, e.g., between zero and ten seconds. In such case, the time difference between adjacent slides in performing a recognition tasks may also be a random value within the same time range as in the training.

FIG. 1, the training process may further include: using the one or more sequences of sample 2D arrays to train one or more weights of the CNN 228 and loading the one or more trained weights 230 into the embedded CeNN of the AI integrated circuit. The trained weights will be used by block 214 in generating the voice recognition result. In training the one or more weights of the CNN, the encoding method may include: for each set of sample training voice data, receiving an indication of a class to which the sample training voice data belong. The type of classes and the number of classes depend on the AI recognition task. For example, a voice recognition task designed to recognize whether a voice is from a male or female speaker may include a binary classifier that assigns any input data into a class of male or female speaker. Correspondingly, the training process may include receiving an indication for each training sample of whether the sample is from a male or female speaker. A voice recognition task may also be designed to verify speaker identity based on the speaker's voice, as can be used in security applications.

In another non-limiting example, a voice recognition task may be designed to recognize the content of the voice input, for example, a syllable, a word, a phrase or a sentence. In each of these cases, the CNN may include a multi-class classifier that assigns each segment of input voice data into one of the multiple classes. Correspondingly, the training process also uses the same CNN structure and multi-class classifier, for which the training process receives an indication for each training sample of one of the multiple classes to which the sample belongs.

Alternatively, and/or additionally, in some scenarios, a voice recognition task may include feature extraction, in which the voice recognition result may include, for example, a vector that may be invariant to a given class of samples, e.g., a given person's utterance regardless of the exact word spoken. In a CNN, both training and recognition may use a similar approach. For example, the system may use any of the fully connected layers in the CNN, after the convolution layers and before the softmax layers. In a non-limiting example, let the CNN have six convolution layers followed by four fully connected layers. In some scenarios, the last fully connected layer may be a softmax layer in which the system stores the classification results, and the system may use the second to last fully connected layer to store the feature vector. There can be various configurations depending on the size of the feature vector. A large feature vector may result in large capacity and high accuracy for classification tasks, whereas a feature vector too large may reduce efficiencies in performing the voice recognition tasks.

The system may use other techniques to train the feature vectors directly without using the softmax layer. Such techniques may include the Siamese network, and methods used in dimension reduction techniques, such as t-Distributed Stochastic Neighbor Embedding (t-SNE), etc.

In some scenarios, in generating one or more sequences of sample 2D frequency-time arrays 226, the encoding method may determine the number of sequences and the number of sample 2D frequency-time arrays in each sequence, based on the duration of the audio waveform segments and the scale of time axis (304, 306 in FIG. 3). For example, if the time step for axis 304 is 100 ms, the time step for axis 306 is 5 ms, and the number of channels for the CNN is 16, then each sample 2D frequency-time array will cover the duration of 100 ms corresponding to the audio waveform, and each sequence of 2D frequency-time array will cover 16×5=80 ms of audio waveform. In a non-limiting example, data can be encoded so that, in the first sample 2D frequency-time array in a sequence, the first column corresponds to time zero and the last column of the same array corresponds to time 100 ms. In the second sample 2D frequency-time array in the sequence, the first column corresponds to time 5 ms, i.e., a 5 ms time shift from its preceding 2D array; and the last column corresponds to time 100 ms+5 ms=105 ms, also a 5 ms shift from the corresponding column in its preceding 2D array. In the last sample (.e.g.,, the 16th 2D array) in the sequence, the first column corresponds to time 80 ms and the last column corresponds to time 100+80=180 ms.

Depending on the duration of segments of audio waveform for sample training voice, the encoding method may determine the number of sequences of sample 2D frequency-time arrays that will be used for training. In training the one or more weights of the CNN (228 in FIG. 2), multiple sequences of sample 2D frequency-time arrays may be loaded into the AI chip in multiple runs, while the results from each run are combined to determine the one or more weights of the CNN. Some methods for updating one or more weights of the CNN may be available. These method may include gradient based methods, such as stochastic gradient descent (SGD) based method or variations thereof. Other non-SGD based methods, such as particle filtering, evolution genetic algorithm or simulated annealing methods are also available.

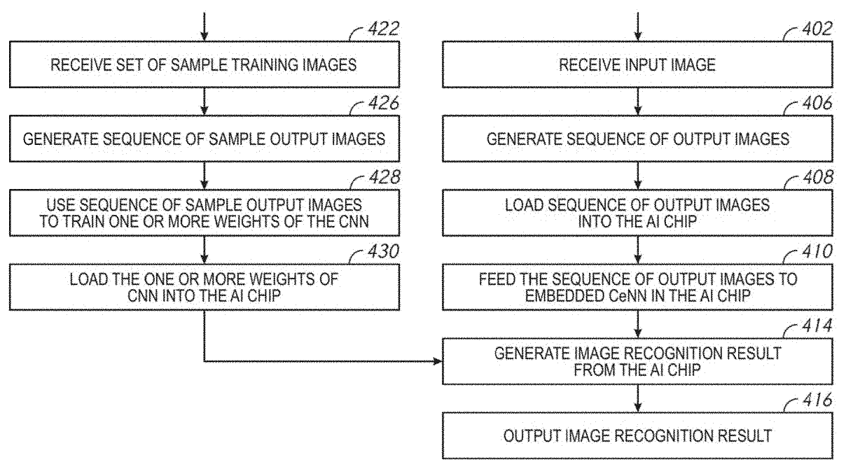

The above described systems and methods with reference to FIG. 1-3 may also be adapted to encoding image data. In FIG. 4, methods of encoding image data for loading into an AI chip are provided. An AI integrated circuit may have an embedded CeNN which may include a number of channels for implementing various AI tasks. In some scenarios, an encoding method may include receiving input image data 402 comprising a size and one or more channels. For example, an input image captured from an image capturing device, such as a camera on a mobile phone, may have a size of 896×896 and three channels, namely, red (R), green (G) and blue (B) channels in a RGB color space. Other image size and number of channels may also be possible. Receiving the input image data 402 may include receiving a sequence of images directly from a image/video sensor, such as a camera. Receiving input image data may also include retrieving image data from a memory. For example, the memory may contain image data captured by a camera. The memory may also contain video data captured by a video capturing device, such as a video camera. The method may retrieve the video data and extract the image data from the video data.

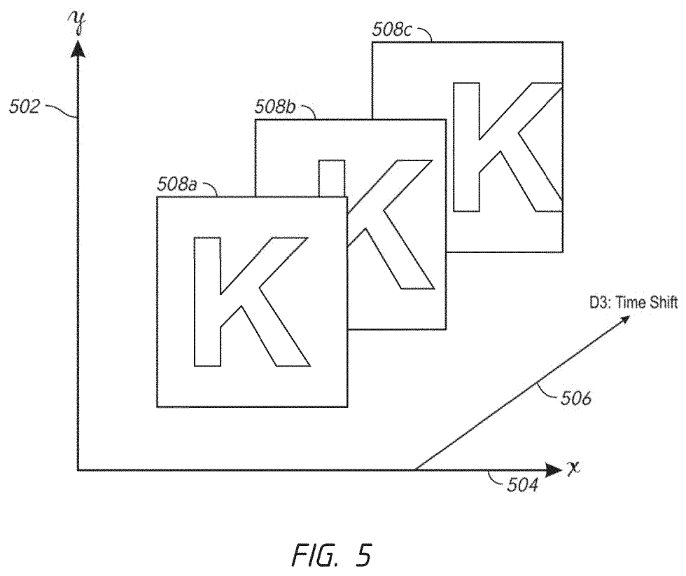

The encoding method may also include generating a sequence of output images using the received input data 406. Each 2D output image in the sequence may represent an input image at a time step. For example, as shown in FIG. 5, the plane that includes x axis 504 and y axis 502 (i.e. x-y plane) may be an image plane that includes an input image. The image may be of any channel of the input image. Each output image in the sequence of output images 508a-508c may represent the input image at a time instance along time axis 506 (D3). In some scenarios, for example, in image recognition, each time step in the sequence of output images may be selected to be small to capture certain transient characteristics of a video signal. For example, an AI chip may have 16 channels, the sequence of output images may have 16 arrays to be respectively uploaded to one of 16 channels in the AI chip. The time difference (i.e., the time step along axis 506) between adjacent output images in the sequence may vary depending on the applications.

In a non-limiting example, in voice application, the input image may be a 2D array of 224 by 224 pixels, and each pixel value may have a depth, such as, for example, 5 bits. An input image may be received as a video is being captured, for example, at 30 frames/second. In some scenarios, axis 506 (D3) may have a time step, for example, at 1 frame/second or 2 frames/second. In other words, each output image in the sequence may be shifted by one frame or two frames per second from its preceding output image. For example, if the time step between two adjacent output images in the sequence is 2 frames/second, and if there are 16 output images in the sequence that correspond to 16 channels in the AI chip, then loading all 16 output images into the AI chip may cover 16×2=32 frames of the video. Similar to voice encoding described above, in some scenarios, a small time step in axis 506 may allow the first layer in an AI chip, for example, a CNN layer in the chip, to be able to see more samples in a small time window. Whereas the output image at each time step may have a low resolution (e.g., 224×224) to fit into the CNN, having multiple images that are proximate in time in a sequence will improve the input precision.

In another non-limiting example, the time difference between output images in the sequence may be larger than 2 frames, 5 frames, or 15 frames per second etc. This will allow the CNN layer in the AI chip to include data that cover a larger time duration in the video signal, and as a result, may improve the accuracy of the AI chip. Because the filter in the CNN now covers longer time duration, the system can capture some transient characteristics of a video, such as events that are further apart in time. For example, traffic light turns red five seconds after the light turns yellow.

Returning to FIG. 4, the method may further include loading the sequence of output images into the AI chip 408. Each of the output images in the sequence may have a captured image frame that is time-shifted by a time difference (i.e., the time step in axis 506) from the preceding output image in the sequence. In loading the sequence of output images into the AI chip 408, each output image in the sequence may respectively be loaded into a corresponding channel in the CeNN in the AI chip. In some scenarios, steps 402-408 may be implemented, by a processing device external to the AI chip. The processing device may also have a peripheral, such as a serial port, a parallel port, or a circuit to facilitate transferring of the output image from a memory or an image sensor to the AI chip.

In generating recognition results for the input image data, the method may further include: executing, by the AI chip, one or more programming instructions contained in the AI chip to feed the sequence of output images 410 into multiple channels in the embedded CeNN in the AI integrated circuit; generating an image recognition result from the embedded CeNN 414 based on the sequence of output images; and outputting the image recognition result 416. Similar to the embodiments described with reference to FIGS. 2-3, outputting the image recognition result 416 may include storing a digital representation of the recognition result to a memory device inside the AI chip or outside the AI chip, the content of the memory can be retrieved by the application running the AI task, an external device or a process. The application running the AI task may be an application running inside an AI integrated circuit should the AI integrated circuit also have a processor. The application may also run on a processor on the communication network (102c-102d) external to the AI chip, such as a computing device or a server on the cloud, which may be electrically coupled to or may communicate remotely with the AI chip. Alternatively, and/or additionally, the AI chip may transmit the recognition result to a processor running the AI application or a display.

In a non-limiting example, the embedded CeNN in an AI integrated circuit may have a maximal number of channels, e.g., , 8, 16, 128 or other numbers, and each channel may have a 2D array, e.g., 224 by 224 pixels, and each pixel value may have a depth, such as, for example, 5 bits. Input data for any AI tasks using the AI chip must be encoded to adapt to such hardware constraints of the AI chip. For example, loading the sequence of output images into the above example of AI chip 408 having 16 channels may include loading a sequence of 16 output images of size 224×224, each pixel of the output image having a 5-bit value. The above described output image sizes, channel number and depth for each channel are illustrative only. Other sizes may be possible.

How to encode image data for the AI chip may also vary. For example, the output images in the sequence may be time shifted by 1 frame, in which case the duration of time for the output images that are loaded into the AI chip will be 16 frames. If the video is captured at 15 frames/second, this data in one “load” in the AI chip spans only about one second. The time shift between adjacent output images in the sequence may also be of a larger time step, for example, 15 frames. In such case, the duration of time for the output images that are loaded into the AI chip will be 15×16=240 frames. If the video is captured at 15 frames/second, this data in one “load” in the AI chip spans 19 seconds.

In some or other scenarios, in generating a sequence of output images 406, an input image having multiple channels (e.g., R, G and B) may result in the sequence of output images also having multiple channels. For example, the sequence of output images may be arranged by channels, such as r0, r1, r2, . . . , g0, g1, g2, . . . , b0, b1, b2, . . . , where r0, r1, r2 . . . are output images representing channel R, each image is time shifted by a time step from the preceding image. Similarly, g0, g1, g2 . . . represent G and are time shifted in sequence; b0, b1, b2 . . . represent B and are time shifted in sequence. In another non-limiting example, the sequence of output images may be arranged in the time each image frame is captured. For example, the sequence of output images may have r0, g0, b0, r1, g1, b1, r2, g2, b2 . . . etc.. In other words, the second three, output image r1 g1, b1 represent three channels of the input image that are time shifted from the preceding output image that also has three channels r0, g0, b0.

Similar to embodiments described above with reference to FIGS. 2-3, the training of the CNN for image recognition may include encoding the training data in the same manner as described in the recognition (e.g., block 402, 496). For example, in some scenarios, a training method may include: receiving a set of sample training images 422; and using the set of sample training images to generate one or more sequences of sample output images 426. Each sequence of sample output image is generated in a similar manner as in block 406. In some scenarios, similar to the process for voice recognition shown in FIG. 2, in generating the sequence of output images, the image size and time shift between adjacent output images in the sequence may be identical to those used in block 402, 406. Alternatively, and/or additionally, the time difference for training and performing recognition task may be a random value in a similar or identical time range.

In FIG. 4, the training process may further include: using the one or more sequences of output images to train one or more weights of the CNN 428 and loading the one or more trained weights 430 into the embedded CeNN of the AI integrated circuit.

The training process may be implemented by a processing device having a processor and may be configured to train one or more weights in the manner described above and store the trained weights in a memory, where the processing device and the memory are external to the AI chip. Similar to block 408, in loading the one or more trained weights 430, the processing device may also have a peripheral, such as a serial port, a parallel port, or a custom-made circuit board to facilitate transferring of the one or more weights of the CNN from a memory of the processing device to the AI chip. Similar to the processes of voice recognition in FIG. 2, both training and recognition processes for image recognition may include converting an image to a frequency domain, e.g., using a Fourier Transform (FTT) followed by a cosine transform to generate a resultant image, and generating the MFC based on the resultant image. This may be useful for images that exhibit periodic or (near periodic) features.

In training the one or more weights of the CNN, the method may include: for each sample input image, receiving an indication of a class to which the sample input image belongs. The type of classes and the number of classes depend on the AI recognition task. For example, an image recognition task designed to recognize a primary object in the image may include a multi-class classifier that assigns any input image into a class of, for example, animal, human, building, scenery, trees, vehicles etc. Alternatively, and/or additionally, each class of the classifier may also have one or more sub-classes. For example, the class corresponding to animal may also have sub-classes, e.g., dog, horse, sheep, cat, etc.. Correspondingly, the training process may include receiving an indication for each sample input image of whether the sample input image is from one of the classes or sub-classes illustrated above.

Alternatively, and/or additionally, in some scenarios, an image recognition task may include feature extraction, in which the image recognition result may include, for example, a vector that may be invariant to a given class of samples, for example, a person's hand writing, or an image of a given person. In a CNN, both training and recognition may use a similar approach. For example, the system may use any of the fully connected layers in the CNN, after the convolution layers and before the softmax layers. For example, let the CNN have six convolution layers followed by four fully connected layers. In some scenarios, the last fully connected layer may be a softmax layer in which the system stores the classification results, and the system may use the second to last fully connected layer to store the feature vector. There can be various configurations depending on the size of the feature vector. A large feature vector may result in large capacity and high accuracy for classification tasks, whereas a too large feature vector may reduce efficiencies in performing the image recognition tasks.

The system may use other techniques to train the feature vectors directly without using the softmax layer. Such techniques may include the Siamese network, and methods used in dimension reduction techniques, such as t-SNE, etc..

In some scenarios, in generating one or more sequences of output images 426, the encoding method may determine the number of sequences and the number of sample output images, based on the duration of the video and the time step along time axis (506 in FIG. 5). For example, if adjacent output images in the sequence (e.g., 508a-508c in FIG. 5) are time shifted by one frame, and the input image is captured at 4 frames/second in monochrome, then the sequence of output images for an AI chip having 16 channels will cover 4 seconds of captured video. Alternatively, the input image may be captured at 4 frames/second in color that has three channels. In such case, the sequence of output images may include images captured at four time instances, each image having three channels for the color. Thus, a total duration of one second of video is encoded into the 16 output images in the sequence. As similar to embodiments described above with reference to FIGS. 2-3, in training the one or more weights of the CNN (428 in FIG. 4), multiple sequences of sample output images may be loaded into the AI chip in multiple runs, while the results from each run are combined to determine the one or more weights of the CNN.

The above illustrated embodiments in FIGS. 1-5 provide advantages in encoding audio/image data that would allow an AI system to detect suitable features for running AI tasks in an AI chip, to improve the precision and accuracy of the system.

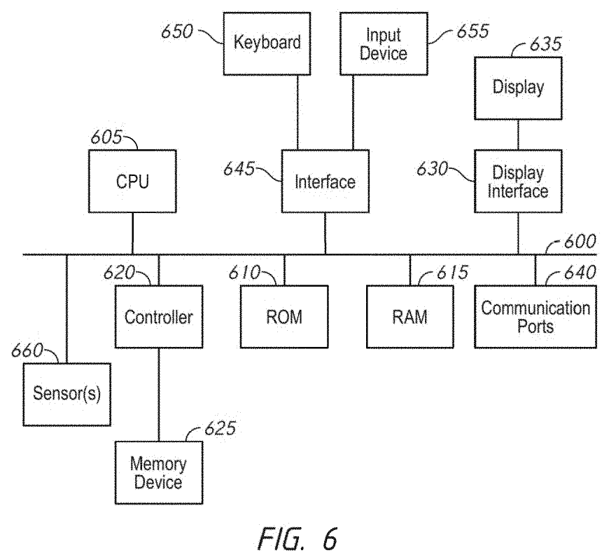

FIG. 6 depicts an example of internal hardware that may be included in any electronic device or computing system for implementing various methods in the embodiments described in FIGS. 1-5. An electrical bus 600 serves as an information highway interconnecting the other illustrated components of the hardware. Processor 605 is a central processing device of the system, configured to perform calculations and logic operations required to execute programming instructions. As used in this document and in the claims, the terms “processor” and “processing device” may refer to a single processor or any number of processors in a set of processors that collectively perform a process, whether a central processing unit (CPU) or a graphics processing unit (GPU) or a combination of the two. Read only memory (ROM), random access memory (RAM), flash memory, hard drives and other devices capable of storing electronic data constitute examples of memory devices 625. A memory device, also referred to as a computer-readable medium, may include a single device or a collection of devices onto which data and/or instructions are stored.

An optional display interface 630 may permit information from the bus 600 to be displayed on a display device 635 in a visual, graphic or alphanumeric format. An audio interface and an audio output (such as a speaker) also may be provided. Communications with external devices may occur using various communication devices 640 such as a transmitter and/or receiver, antenna, an RFID tag and/or short-range or near-field communication circuitry. A communication device 640 may be attached to a communications network, such as the Internet, a local area network (LAN) or a cellular telephone data network.

The hardware may also include a user interface sensor 645 that allows for receipt of data from input devices 650 such as a keyboard, a mouse, a joystick, a touchscreen, a remote control, a pointing device, a video input device and/or an audio input device, such as a microphone. Digital image frames may also be received from an imaging capturing device 655 such as a video or camera that can either be built-in or external to the system. Other environmental sensors 660, such as a GPS system and/or a temperature sensor, may be installed on system and communicatively accessible by the processor 605, either directly or via the communication device 640. The communication ports 640 may also communicate with the AI chip to upload or retrieve data to/from the chip. For example, the computer system may implement the encoding methods and upload the trained CNN weights or the sequence of 2D arrays or sequence of output images to the AI chip via the communication port 640. The communication port 640 may also communicate with any other interface circuit or device that is designed for communicating with an integrated circuit.

Optionally, the hardware may not need to include a memory, but instead programming instructions are running on one or more virtual machines or one or more containers on a cloud. For example, the various methods illustrated above may be implemented by a server on a cloud that includes multiple virtual machines, each virtual machine having an operating system, a virtual disk, virtual network and applications, and the programming instructions for implementing various functions in the robotic system may be stored on One or more of those virtual machines on the cloud.

Various embodiments described above may be implemented and adapted to various applications. For example, an AI integrated circuit having a cellular neural network architecture may be residing in an electronic mobile device. The electronic mobile device may also have a voice or image capturing device, such as a microphone or a video camera for capturing input audio/video data, and use the built-in AI chip to generate recognition results. In some scenarios, training for the CNN can be done in the mobile device itself, where the mobile device captures or retrieves training data samples from a database and uses the built-in AI chip to perform the training. In other scenarios, training can be done in a service device or on a cloud. These are only examples of applications in which an AI task can be perform in the AI chip.

The above illustrated embodiments are described in the context of implementing a CNN solution in an AI chip, but can also be applied to various other applications. For example, the current solution is not limited to implementing CNN but can also be applied to other algorithms or architectures inside a chip. The voice encoding methods can still be applied when the bit-width or the number of channels in the chip varies, or when the algorithm changes.

It will be readily understood that the components of the present solution as generally described herein and illustrated in the appended figures could be arranged and designed in a wide variety of different configurations. Thus, the following more detailed description of various implementations, as represented in the figures, is not intended to limit the scope of the present disclosure, but is merely representative of various implementations. While the various aspects of the present solution are presented in drawings, the drawings are not necessarily drawn to scale unless specifically indicated.

The present solution may be embodied in other specific forms without departing from its spirit or essential characteristics. The described embodiments are to be considered in all respects only as illustrative and not restrictive. The scope of the present solution is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present solution should be or are in any single embodiment thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One ordinarily skilled in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

Other advantages can be apparent to those skilled in the art from the foregoing specification. Accordingly, it will be recognized by those skilled in the art that changes, modifications or combinations may be made to the above-described embodiments without departing from the broad inventive concepts of the invention. It should therefore be understood that the present solution is not limited to the particular embodiments described herein, but is intended to include all changes, modifications, and all combinations of various embodiments that are within the scope and spirit of the invention as defined in the claims.

We claim:

1. A method comprising:
receiving by a processor, voice data comprising at least a segment of an audio waveform;
generating, by the processor, a sequence of two-dimensional (2D) frequency-time arrays, each 2D frequency-time array comprising a plurality of pixels, wherein each 2D frequency-time array in the sequence is shifted from a preceding 2D frequency-time array by a first time difference;
loading the sequence of 2D frequency-time arrays into an AI integrated circuit.

2. The method of claim 1, wherein each of the 2D frequency-time arrays is a 2D spectrogram, herein each pixel in each 2D frequency-time array has a value that represents an audio intensity of the segment of the audio waveform at a time in the segment and a frequency in the audio waveform.

3. The method of claim 2 further comprising generating a 2D mel-frequency cepstrum (MFC) based on each 2D frequency-time array so that each pixel in each 2D frequency-time array becomes MFC coefficient.

4. The method of claim 1 further comprising, by the AI integrated circuit:
executing one or more programming instructions contained in the AI integrated circuit to feed each of the 2D frequency-time arrays in the sequence into a respective channel in an embedded cellular neural network architecture in the AI integrated circuit;
generating a voice recognition result from the embedded cellular neural network architecture based on the sequence of 2D arrays; and
outputting the voice recognition result.

5. The method of claim 4, further comprising:
receiving a set of sample training voice data comprising at least one sample segment of an audio waveform;
using the set of sample training voice data to generate a sequence of sample 2D frequency-time arrays each comprising a plurality of pixels, wherein each sample 2D frequency-time array in the sequence is shifted from a preceding sample 2D frequency-time array by a second time difference;
using the sequence of sample 2D frequency-time arrays to train one or more weights of a convolutional neural network; and
loading the one or more trained weights into the embedded cellular neural network architecture of the AI integrated circuit.

6. A system for encoding voice data for loading into an artificial intelligence (AI) integrated circuit, the system comprising:
a processor, and
a non-transitory computer readable medium containing programming instructions that, when executed, will cause the processor to:
receive voice data comprising at least a segment of an audio waveform,
generate a sequence of two-dimensional (2D) frequency-time arrays, each 2D frequency-time array comprising a plurality of pixels, wherein each 2D frequency-time array in the sequence is shifted from a preceding 2D frequency-time array by a first time difference;
load the sequence of 2D frequency-time arrays into the AI integrated circuit.

7. The system of claim 6, wherein each of the 2D frequency-time arrays is a 2D spectrogram, wherein each pixel in each 2D frequency-time array has a value that represents an audio intensity of the segment of the audio waveform at a time in the segment and a frequency in the audio waveform.

8. The system of claim 6, wherein the programming instructions comprise additional programming instructions configured to generate a 2D mel-frequency cepstrum (MFC) based on each 2D frequency-time array so that each pixel in each 2D frequency-time array is a MFC coefficient.

9. The system of claim 6, wherein the AI integrated circuit comprises:
an embedded cellular neural network architecture; and
one or more programming instructions configured to:
feed each of the 2D frequency-time arrays in the sequence into a respective channel in the embedded cellular neural network architecture in the AI integrated circuit;
generate a voice recognition result from the embedded cellular neural network architecture based on the sequence of 2D arrays; and
output the voice recognition result.

10. The system of claim 9 further comprising additional programming instructions configured to cause the processor to:
receive a set of sample training voice data comprising at least one sample segment of an audio waveform;
use the set of sample training voice data to generate a sequence of sample 2D frequency-time arrays each comprising a plurality of pixels, wherein each sample 2D frequency-time array in the sequence is shifted from a preceding sample 2D frequency-time array by a second time difference;
use the sequence of sample 2D frequency-time arrays to train one or more weights of a convolutional neural network; and
load the one or more trained weights into the embedded cellular neural network architecture of the AI integrated circuit.

11. A method of encoding image data for loading into an artificial intelligence (AI) integrated circuit, the method comprising:
receiving, by a processor, an input image having a plurality of pixels;
by the processor, using the input image to generate a sequence of output images, wherein each output image in the sequence is shifted from a preceding output image by a first time difference; and
loading the sequence of output images into the AI integrated circuit.

12. The method of claim 11 further comprising:
receiving an additional input image;
using the additional input image to generate an additional sequence of output images, wherein each output image in the additional sequence is shifted from a preceding output image by the first time difference; and
loading the additional sequence of output images into the AI integrated circuit.

3. The method of claim 12, wherein the input image and the additional input image are corresponding channels of a multi-channel input image.

14. The method of claim 11, further comprising, by the AI integrated circuit, executing one or more programming instructions contained in the AI integrated circuit to:
feed each output image in the sequence into a respective channel in an embedded cellular neural network architecture in the AI integrated circuit;
generate an image recognition result from the embedded cellular neural network architecture based on the sequence of output images; and
output the image recognition result.

15. The method of claim 14, further comprising, by a processor:
receiving a set of sample training images comprising one or more sample input images, each sample input image having a plurality of pixels;
for each sample input image:
generating a sequence of sample output images, wherein each sample output image in the sequence is shifted from a preceding sample output image by a second time difference;
using one or more sample output images generated from the one or more sample input images to train one or more weights of a convolutional neural network; and
loading the one or more trained weights of the convolutional neural network into the embedded cellular neural network architecture in the AI integrated circuit.

16. A system for encoding image data for loading into an artificial intelligence (AI) integrated circuit, the system comprising:
a processor; and
a non-transitory computer readable medium containing programming instructions that, when executed, will cause the processor to:
receive an input image having a plurality of pixels;
use the input image to generate a sequence of output images, wherein each output image in the sequence is shifted from a preceding output image by a first time difference; and
load the sequence of output images into the AI integrated circuit.

17. The system of claim 16, wherein programming instructions comprise additional programming instructions that will cause the processor to:
receive an additional input image;
use the additional input image to generate an additional sequence of output images, wherein each output images in the additional sequence is shifted from a preceding output image by the first time difference; and
load the additional sequence of output images into the AI integrated circuit.

18. The system of claim 17, wherein the input image and the additional input image are corresponding channels of a multi-channel input image.

19. The system of claim 16, wherein the AI integrated circuit comprises:
an embedded cellular neural network architecture; and
one or more programming instructions configured to:
feed each output image in the sequence into a respective channel in the embedded cellular neural network architecture in the AI integrated circuit;
generate an image recognition result from the embedded cellular neural network architecture based on the sequence of output images; and
output the image recognition result.

20. The system of claim 16 further comprising additional programming instructions configured to cause the processor to:
receive a set of sample training images comprising one or more sample input images, each sample input image having a plurality of pixels;
for each sample input image:
generate a sequence of sample output images, wherein each sample output image in the sequence is shifted from a preceding sample output image by a second time difference;
use one or more sample output images generated from the one or more sample input images to train one or more weights of a convolutional neural network; and
load the one or more trained weights of the convolutional neural network into the embedded cellular neural network architecture in the AI integrated circuit.
